(19) United States
(12) Patent Application Publication
(10) Pub. No.: US 2006/0277924 A1
(43) Pub. Date: Dec. 14, 2006

(54) Cold hot server

(76) Inventor: Robert Platkin, San Mateo, CA (US)

Correspondence Address: Thomas B. Haverstock;HAVERSTOCK & OWENS LLP, 162 North Wolfe Road, Sunnyvale, CA, 94086, US

(21) Appl. No.: 11/449,506

(22) Filed: Jun. 7, 2006

Related U.S. Application Data
(60) Provisional application No. 60/689,598, filed on Jun. 9, 2005.

(51) Int. Cl. F25B 21/02; F17C 13/00

(52) U.S. Cl. 62/3.3; 62/457.9

(57) ABSTRACT

A buffet server includes a thermoelectric device, a base, a pan, and a transfer plate. The thermoelectric device is for providing a temperature that varies from an ambient temperature. The base is for housing the thermoelectric device. The pan is for receiving the temperature and the transfer plate is for providing a thermal transfer interface. The transfer plate is interposed between the pan and the thermoelectric device.

### RELATED APPLICATIONS

This application claims benefit of priority under 35 U.S.C. section 119(e) of U.S. Provisional Patent Application 60/689,598, filed Jun. 9, 2005, and entitled “Cold Hot Buffet Server,” which is incorporated herein by reference in its entirety.

### FIELD OF THE INVENTION

The present invention is related to buffet service equipment. More specifically the present invention is directed to cold hot server.

### BACKGROUND

In the presentation of food and/or beverages such as for a buffet service, it is often desirable to store, transport, and/or present the buffet items in a convenient, presentable fashion. It is often further desirable to provide the items either above or below the ambient temperature of the presentation environment. Moreover, in-home hosting has trended upward, and could benefit from equipment improvement. Further, the costs and convenience of improved buffet service, storage, transportation, and/or presentation means can further be improved such that they are more accessible and feasible in the market place.

### SUMMARY OF THE INVENTION

A server includes a thermoelectric device, a base, a pan, and a transfer plate. The thermoelectric device is for providing a temperature that varies from an ambient temperature. The base is for housing the thermoelectric device. The pan is for receiving the temperature and the transfer plate is for providing a thermal transfer interface. The transfer plate is interposed between the pan and the thermoelectric device. The pan, when empty, abuts only the transfer plate such that the surface of the pan, that is not in contact with the transfer plate, is surrounded by a fluid.

In some embodiments, the fluid surrounding the pan comprises air, which provides a thermal buffer. Preferably, the transfer plate is coupled to the thermoelectric device by a thermally conductive material. The pan of some embodiments has a protrusion, and the transfer plate of these embodiments has a recessed portion that mates with the protrusion. The transfer plate of some embodiments includes a well for retaining a fluid within a perimeter of the transfer plate. The well typically provides an indicator or an icon for a preferred fluid quantity or level. In some of these implementations, the well is a recessed groove that extends fully around the perimeter of the transfer plate.

The server of some embodiments further includes an insulation layer disposed between the pan and the base. This insulation layer typically has a foam component, such as a foam layer. In some embodiments, a hermetic seal is formed between the insulation layer and the thermoelectric device. Advantageously, the pan preferably has the dimensions of a standard buffet serving tray, such as a standard commercial size serving tray, for example, or a standard consumer size serving tray, as another example. The buffet server also typically includes a pan cover for enclosing the contents of the pan. The pan cover alternatively comprises a variety of materials including a polypropylene, polyethylene, polycarbonate, aluminum, or stainless steel, for example.

The pan cover of some embodiments is configured to mate with the bottom of the pan. This allows multiple pans of food with the pan cover in place to be stacked in a non-slidable relationship.

Some embodiments further include a server cover for enclosing the buffet server. The server cover of some of these embodiments is formed by using a polycarbonate type material.

The server of some embodiments can include a fan configured to provide air flow. The base of such embodiments preferably provides a clearance for air passage, such as by using a vent on a side of the base, or by another means. Generally, the fan is desired to remove heat from under the buffet server when the thermoelectric device is operated to cool the food, and collect heat in the warming cycle.

The thermoelectric device is preferably a Peltier type device. The buffet server also typically has a control module for adjusting the temperature. Hence, the control module of these embodiments is generally configured to receive a desired temperature setting. Some embodiments further include a display for indicating a temperature setting. Preferably, the display can selectively present the temperature in degrees Farenheit or Celsius.

A server includes a thermoelectric device, a base, a pan, and a transfer plate. The thermoelectric device is for providing a temperature that varies from an ambient temperature. The base is for housing the thermoelectric device and the pan is for receiving the temperature to cool or warm food. The transfer plate is interposed between the pan and the thermoelectric device, and is for providing a thermal transfer interface. The thermal transfer interface comprises a protrusion and a recessed portion. The recessed portion is configured to mate with the protrusion.

The recessed portion is configured for mating with the protrusion such that the pan and the transfer plate align in a predetermined configuration. The mating configuration of the recessed portion and the protrusion are such that thermal transfer is enhanced. Some embodiments have a thermal transfer fluid deposed between the pan and the transfer plate.

A server includes a thermoelectric device, a base, a pan, and a transfer plate. The thermoelectric device is for providing a temperature that varies from an ambient temperature. The base is for housing the thermoelectric device. The pan is for receiving the temperature. The transfer plate is interposed between the pan and the thermoelectric device, and is for providing a thermal transfer interface. The transfer plate has a well for retaining a fluid within a perimeter of the transfer plate.

### BRIEF DESCRIPTION OF THE DRAWINGS

The novel features of the invention are set forth in the appended claims. However, for purpose of explanation, several embodiments of the invention are set forth in the following figures.

FIG. 1 illustrates an exploded view of a buffet server in accordance with some embodiments of the invention.

FIG. 2 illustrates an assembled view of a buffet server in accordance with some embodiments.

FIG. 3 illustrates an alternatively hinged and/or removable server cover in accordance with some embodiments.

FIG. 4 illustrates the stackable pan cover of some embodiments.

FIG. 5 illustrates a side (cross section) view of the base and pan of some embodiments.

FIG. 6 illustrates a schematic plan view of the base of some embodiments in further detail.

FIG. 7 illustrates a perspective view of a pan interfacing with a transfer plate according to some embodiments.

FIG. 7A illustrates the interfacing of FIG. 7, with the protrusion and recessed portion in a reversed configuration.

FIG. 7B illustrates a circular shaped pan in accordance with some embodiments.

FIG. 8 illustrates a pan having a recessed portion and a transfer plate having a protrusion.

FIG. 8A illustrates a side view of a pan interfacing with a transfer plate according to some embodiments where the protrusion and the recessed portion fit closely together.

FIG. 8B illustrates a side view of a protrusion interfacing with a transfer plate that has a recessed portion and an additional peripheral groove in accordance with some embodiments.

FIG. 8C illustrates a side view of a protrusion interfacing with a transfer plate that has a recessed portion that is slightly larger than the protrusion such that the peripheral groove is integrated with the recessed portion.

FIG. 8D illustrates an additional well within the recessed portion.

FIG. 8E illustrates a roughened surface for the protrusion and/or the recessed portion.

FIG. 9A illustrates a plan view of a pan interfacing with a closely fitting recessed portion of a transfer plate according to some embodiments.

FIG. 9B illustrates a plan view of a protrusion interfacing with a transfer plate that has a recessed portion and an additional peripheral groove in accordance with some embodiments.

FIG. 9C illustrates a plan view of a protrusion interfacing with a transfer plate that has a recessed portion that is slightly larger than the protrusion such that the peripheral groove is integrated within the recessed portion.

FIG. 9D illustrates an additional well within the recessed portion.

FIG. 9E illustrates a roughened surface for the protrusion and/or the recessed portion.

FIG. 10 illustrates that the interlocking feature of some embodiments is separate from the protrusion and recessed portion.

### DETAILED DESCRIPTION OF THE INVENTION

In the following description, numerous details and alternatives are set forth for purpose of explanation. However, one of ordinary skill in the art will realize that the invention can be practiced without the use of these specific details. In other instances, well-known structures and devices are shown in block diagram form in order not to obscure the description of the invention with unnecessary detail.

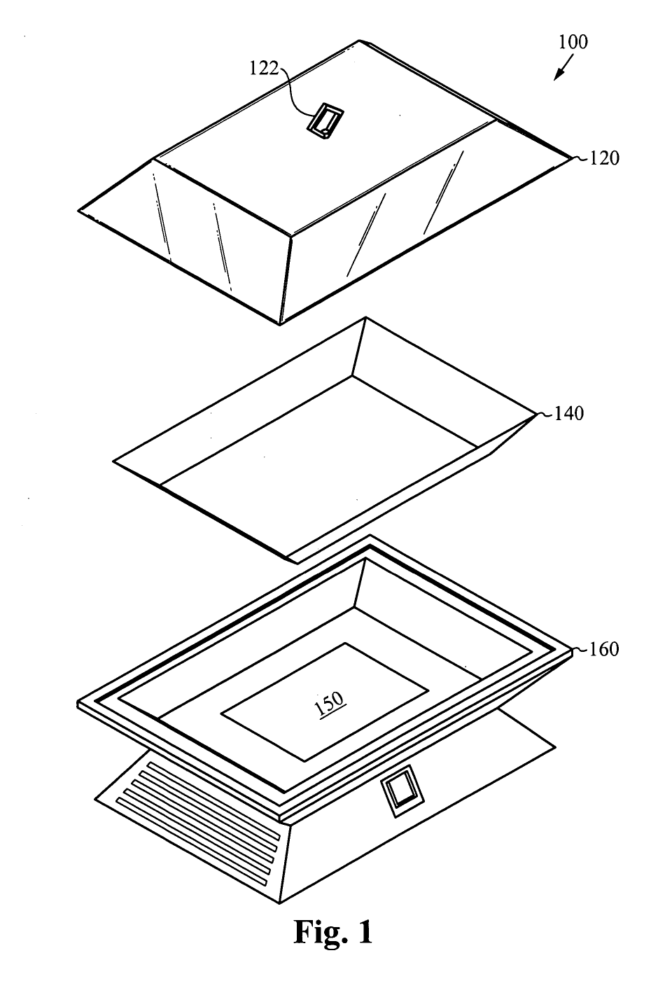

FIG. 1 illustrates a server 100 in accordance with embodiments of the invention. The server 100 is advantageously used to extend the normal serving time of food by keeping food cooler or warmer than an ambient temperature. As shown in FIG. 1, the server 100 includes a server cover 120, a pan 140 optionally having a pan cover 142, and a base 160.

Server Cover

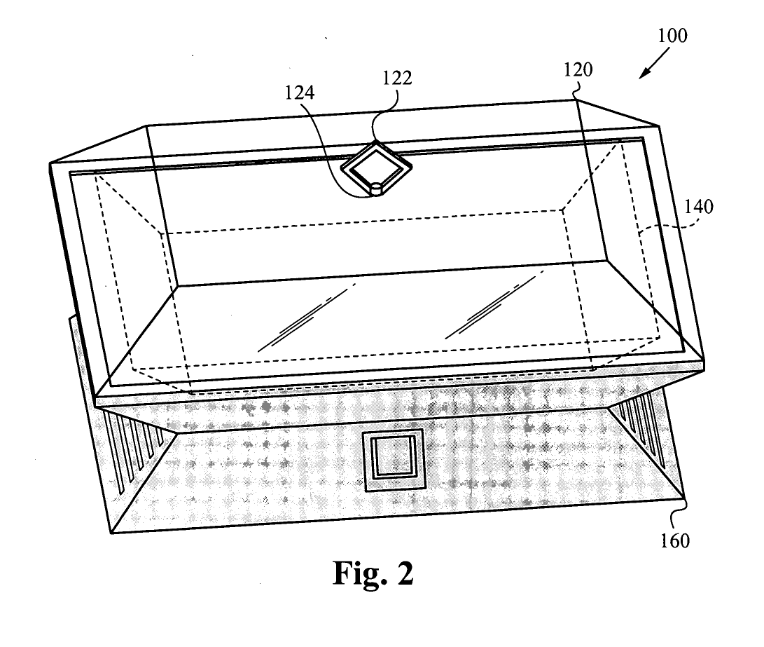

As illustrated in FIGS. 1, 2 and 3, in some embodiments the server cover 120 is advantageously placed over the base 160 to enclose, insulate, and protect the pan 140 and its contents from the environment external to the server 100. The server cover 120 is typically formed by using a transparent material that is also preferably thermally insulating, such as a plastic, for example. The server cover 120 is preferably formed of a polycarbonate type material. FIG. 2 illustrates the server 100 of some embodiments fully assembled with a removable server cover 120 enclosing the pan 140 and the top surfaces of the base 160.

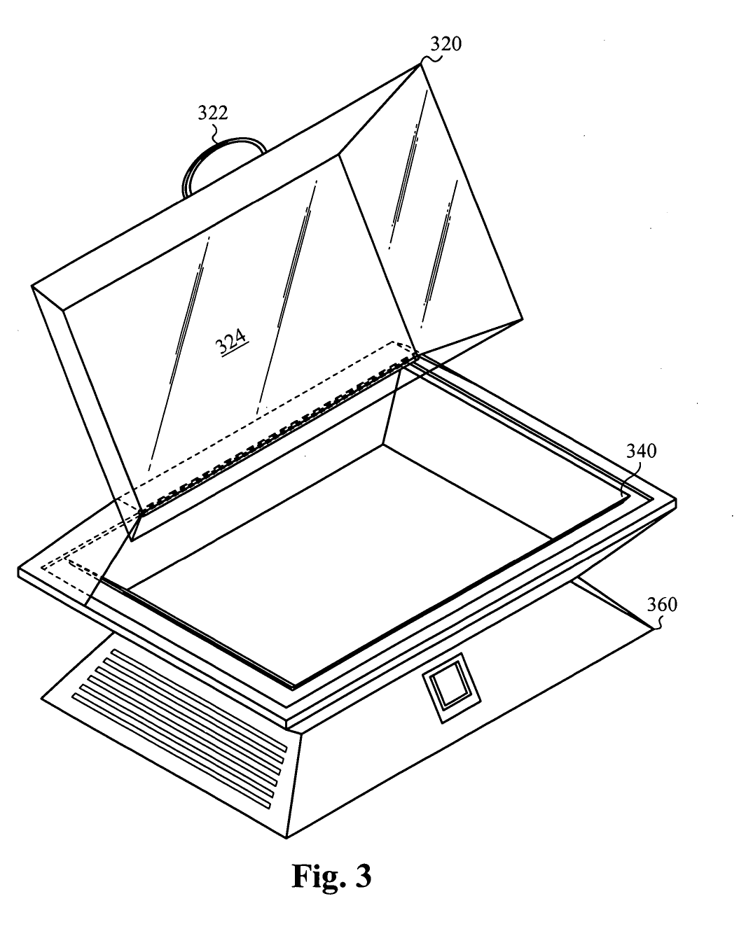

As particularly illustrated in FIG. 3, the server cover 320 is alternatively removable or hinged. If hinged, the server cover 320 is optionally hinged to the base 360 or centrally hinged such that it folds back over or into itself. In some of these embodiments, removable inserts, such as pins, for example, are optionally used to secure a portion of the server cover 320 to the base 360. The server cover 320 of these embodiments, is further configured, when the inserts are present, to remain attached to the base 360, whether the server cover 320 is in a closed or an open position.

A handle 122 and 322 is optionally attached to the server cover 120 and 320 to allow a user to easily remove or open the server cover 120 and 320. Additionally, as illustrated in FIG. 2, the server cover 120 optionally includes a venting means 124 to allow heat, vapor, or both, to escape from the server cover 120 and to diminish the likelihood or amount of condensation developing inside the server 100. The venting means 124 of some embodiments is an aperture 124 that is incorporated into the handle 122 such that the handle 122 further acts to keep foreign particles out of the interior of the server 100.

Pan

Beneath the server cover 120, an independently removable pan 140 is typically placed on a surface of the base 160 during operation of the server 100. The pan 140 generally has similar dimensions to a top surface of the base 160 such that it rests within the base 160. The interface between the pan 140 and the components of the base 160 is discussed in further detail below.

Preferably, the pan 140 is formed by using a material having high heat transfer capacity, such as aluminum, stainless steel, an alloy, or a combination of materials, such as in a laminate composition, for example. Moreover, the pan 140 is often coated with a substance to improve a variety of its features such as heat transfer, durability, particle, chemical, and/or scratch resistance, ease of cleaning, or another functional and/or aesthetic feature. Preferably, the pan 140 is treated or engineered so that it does not become warped during its normal operation. The pan 140 often further includes handles so that it is readily removed and used as a mobile serving pan. The pan of some of these embodiments advantageously has the dimensions of a standard buffet tray, or a common fraction thereof.

Stackable Pan Cover

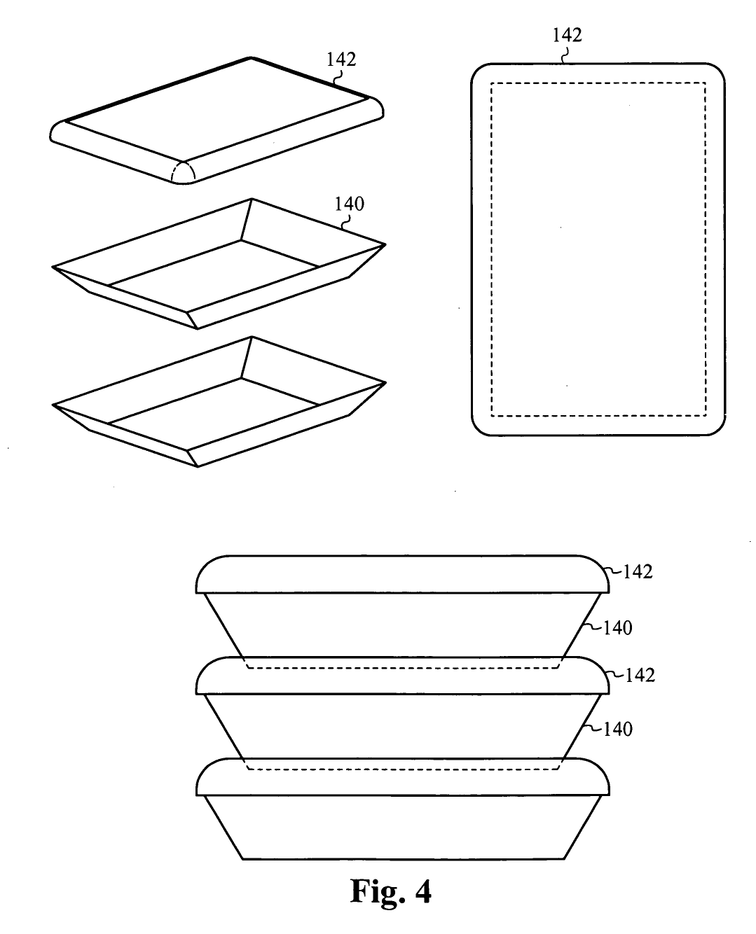

FIG. 4 illustrates a stacking feature for some embodiments. As shown in this figure, some embodiments further include a removable pan cover 142 that is placed over the pan 140 to insulate its contents from the ambient temperature, and to separate, and/or to protect the contents from foreign matter, especially during transport such as from a kitchen. The pan cover 142 is typically formed from a transparent material such as a plastic, and preferably includes a thermally insulating material. For instance, the pan cover 142 alternatively comprises a variety of materials including a polypropylene, polyethylene, polycarbonate, aluminum, or stainless steel, for example. The pan cover 142 of some embodiments is configured to mate with the bottom of the pan 140 such that the pan 140 and the pan cover 142 are stackable. The interlocking features of the pan 140 and pan cover 142 have particular advantages for storage and/or transportation of multiple covered pans, in a stack or rack of covered pans, for example. Additionally, the pan cover 142 of some embodiments includes venting means to allow air and/or heat to escape from the pan 140 such that condensation within the pan 140 is reduced.

The pan 140 is for receiving a temperature setting from the base 160. The temperature is typically transferred from components within the base 160 to the pan 140 via a transfer plate 150. Hence, the transfer plate 150 is preferably interposed between the pan 140 and one or more components within the base 160, such as a thermoelectric device, for example. These components are discussed in further detail below.

Base

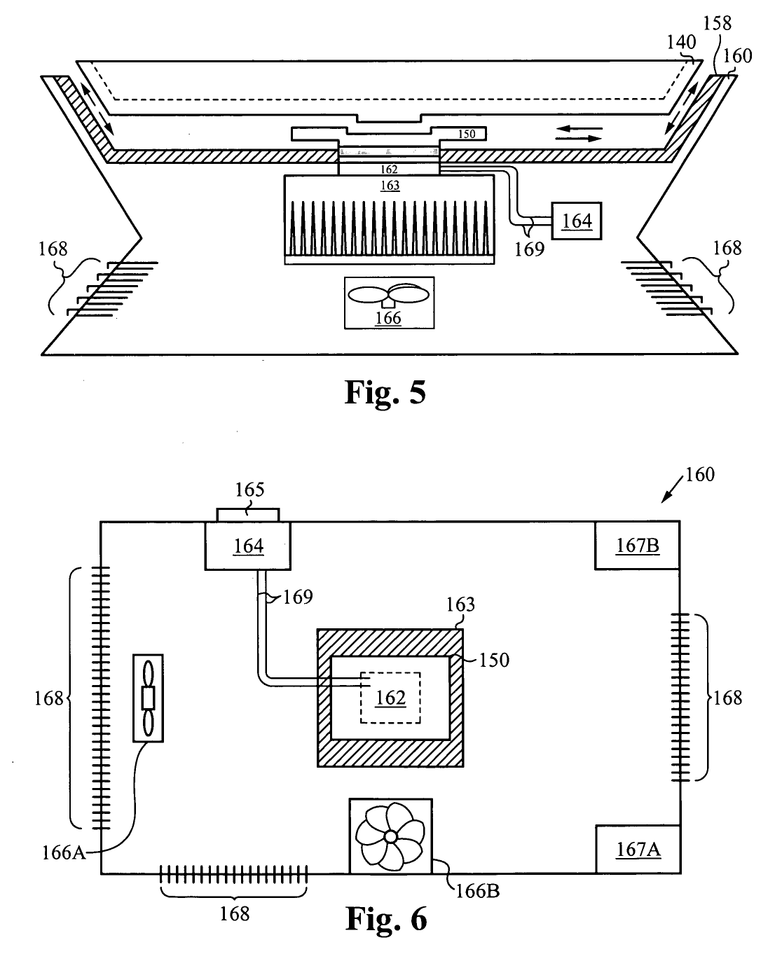

As mentioned above, the base 160 typically houses several additional components of the server 100. FIGS. 5 and 6 illustrate the base 160 of some embodiments in further detail. As shown in these figures, the base 160 includes a thermoelectric device 162, a control module 164 coupled to the thermoelectric device 162 by wires 169, one or more fans 166, one or more power modules 167, and one or more vents 168. As mentioned above, the base 160 of some embodiments further includes a thermal transfer plate 150 and/or a thermal insulation layer 158. Some embodiments advantageously provide power separately to the thermoelectric device 162 and the other components, such as the fans 166 and/or the control module 164, by using separate power modules 167.

Thermoelectric Device and Control

The thermoelectric device 162 is for receiving power from the power module(s) 167, and providing a temperature that varies from an ambient temperature. The thermoelectric device 162 preferably includes a Peltier type device that is used to heat or cool a thermally conductive surface depending upon the direction of electric current flowing in the device. For instance, a first surface of the thermoelectric device 162 is advantageously mounted to the thermal transfer plate 150, which is typically made of thermally conductive metal such as aluminum, for example. In some embodiments, the dimensions of the thermal transfer plate 150 is on the order of four by six inches. Typically, the serving pan 140 is larger than the thermal transfer plate 150, such as approximately the size of a standard buffet serving tray.

The opposite or second surface of the thermoelectric device 162 preferably has a finned “heat sink” 163 mounted thereon for transfer and removal of unwanted heat from the pan 140, when the thermoelectric device 162 provides a cooling function to the transfer plate 150 and the pan 140.

Although the second surface is coupled to what is termed as a “heat sink,” the thermal transfer plate 150 and/or the heat sink 163 are alternatively heated or cooled depending on the direction of electric current flow through the thermoelectric device 162. Accordingly, one or more fans 166 are advantageously positioned to blow air over the finned heat sink 163 and reject an accumulation of heat from the base 160 during the cooling operation of the server 100. One of ordinary skill recognizes that cold air is alternatively removed from the base 160, when the server 100 operates to heat the transfer plate 150 and/or the pan 140. Since one of ordinary skill recognizes these alternative embodiments, the discussion herein generally refers to the operation of the server 100 when the thermoelectric device 162 provides a cooling function to the transfer plate 150 and the pan 140, except where noted.

Typically, one or more vents 168 in the base 160 allow the blown air to escape the base 160. As illustrated in the figures, the vents 168 of some embodiments are oriented horizontally with respect to the base 160, and further include coverings that allow the passage of air, but prevent the entry of undesirable material such as food particles and/or fluids into the base 160.

Control

Some embodiments include a variable temperature control module 164. The control module 164 of some of these embodiments further includes a user access interface at an exterior of the base 160 to allow a user to input the desired target temperature for the transfer plate 150, the pan 140, and/or the server 100. The user access interface can preferably include a push button panel, or a rotary dial switch. Separately, or in conjunction with, the control module 164, some embodiments further include a display panel 165 for displaying the temperature of the pan 140. Preferably, the control module 164 and/or the display 165 operate by using the Celsius and/or Fahrenheit temperature measurement systems. A heat or cool control switch is preferably attached to the exterior of the server 100 to allow a user to adjust whether to heat or cool the contents of the server 100 and/or the pan 140. The user adjustable controls of some embodiments are integrated with the display 165 that is coupled to the control module 164.

The server 100 of some embodiments also includes a first fan 166A configured to provide horizontal air flow, a second fan 166B configured to provide vertical air flow, or both. The base 160 of various embodiments preferably provides a clearance for air passage, such as by using one or more vents 168, or by another means.

Transfer Plate and Thermal Interface

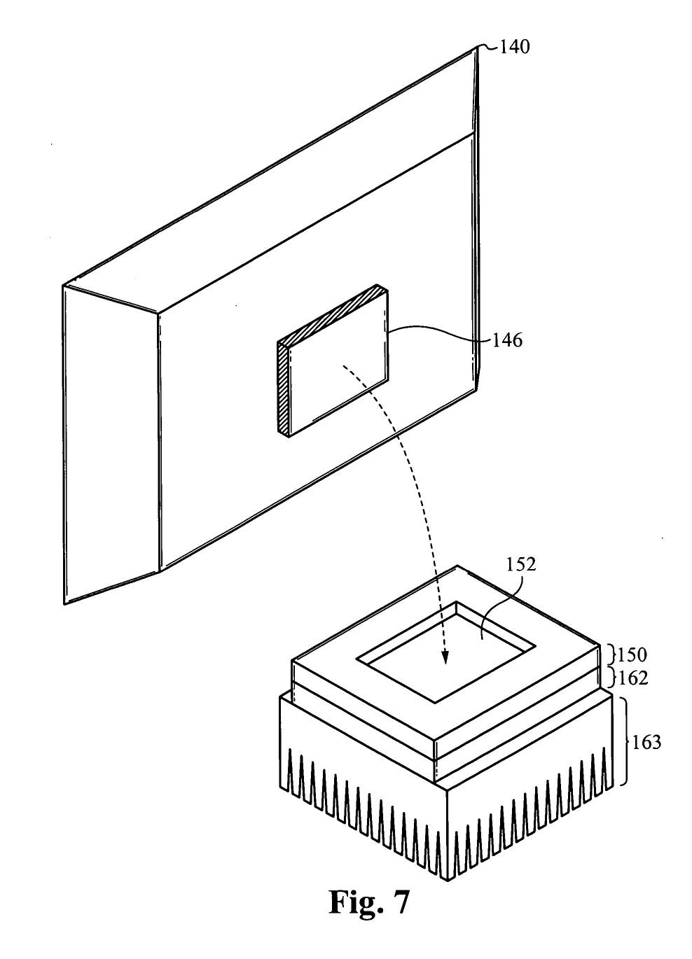

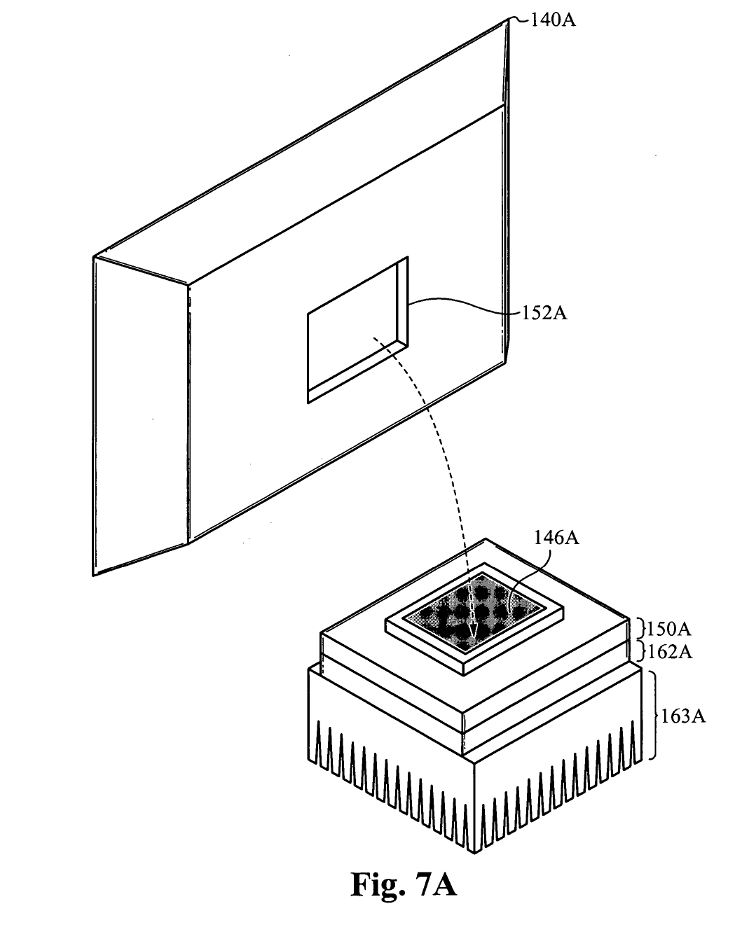

FIG. 7 illustrates the transfer plate 150 of some embodiments in further detail. As shown in this figure, the transfer plate 150 is preferably interposed between the pan 140 and the thermoelectric device 162, and is for providing a thermal transfer interface. Preferably, the transfer plate 150 is coupled to the thermoelectric device 162 by using an adhesive or a paste, which further typically comprises a thermally conductive material. The thermal transfer interface is enhanced, in some embodiments, by a protrusion 146 and a recessed portion 152. In these embodiments, the recessed portion 152 is configured to mate with the protrusion 146. In some embodiments, the recessed portion 152A is located on the bottom surface of the pan 140A, while the protrusion 146A is located on a top surface of the transfer plate 150A. Such an embodiment is illustrated in FIG. 7A. However, one of ordinary skill recognizes that this arrangement can be reversed (as illustrated in FIG. 7), and also that additional configurations for the protrusion 146 and recessed portion 152, can be used. Preferably, the recessed portion 152 is configured for mating with the protrusion 146 such that the pan 140 and the transfer plate 150 align in a predetermined configuration. The mating configuration of the recessed portion 152 and the protrusion 146 are such that thermal transfer is enhanced.

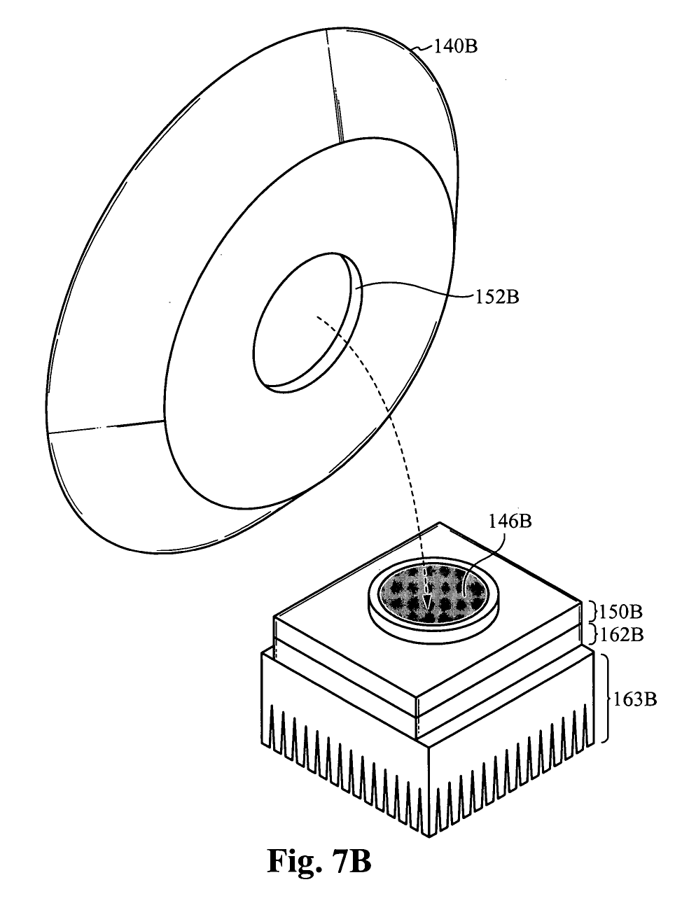

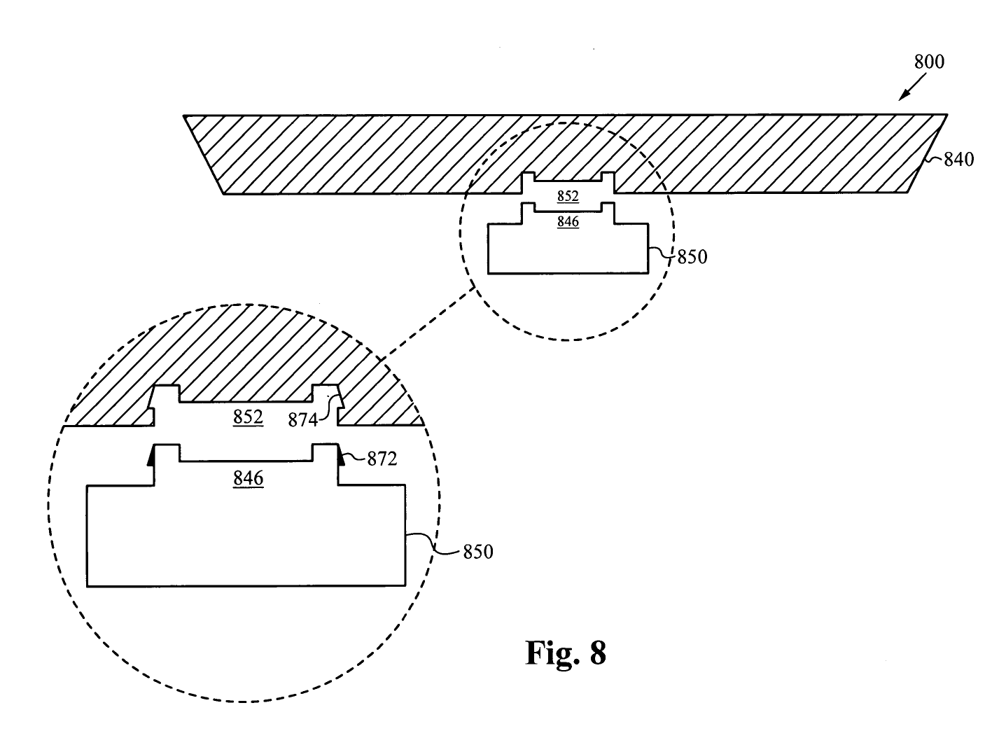

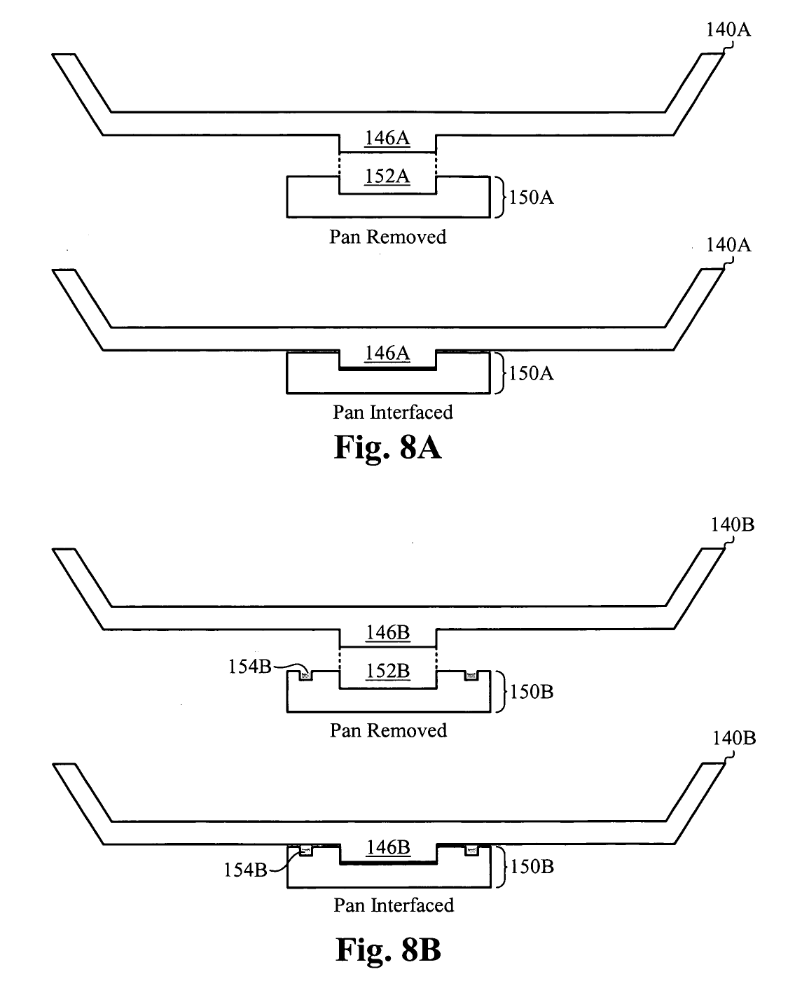

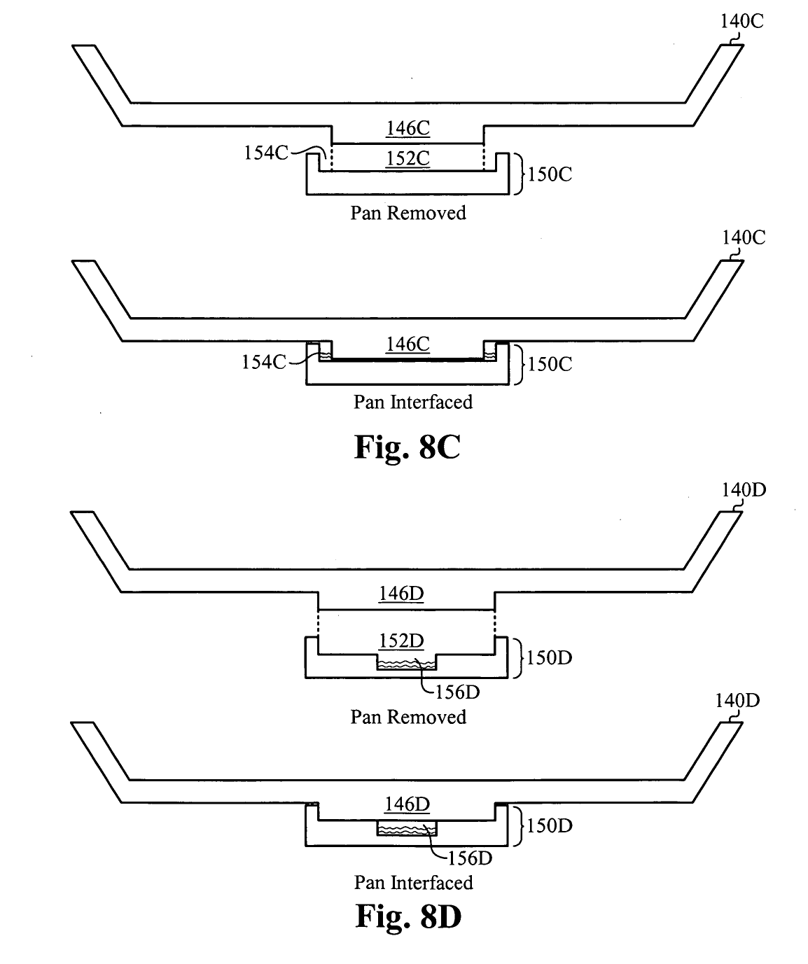

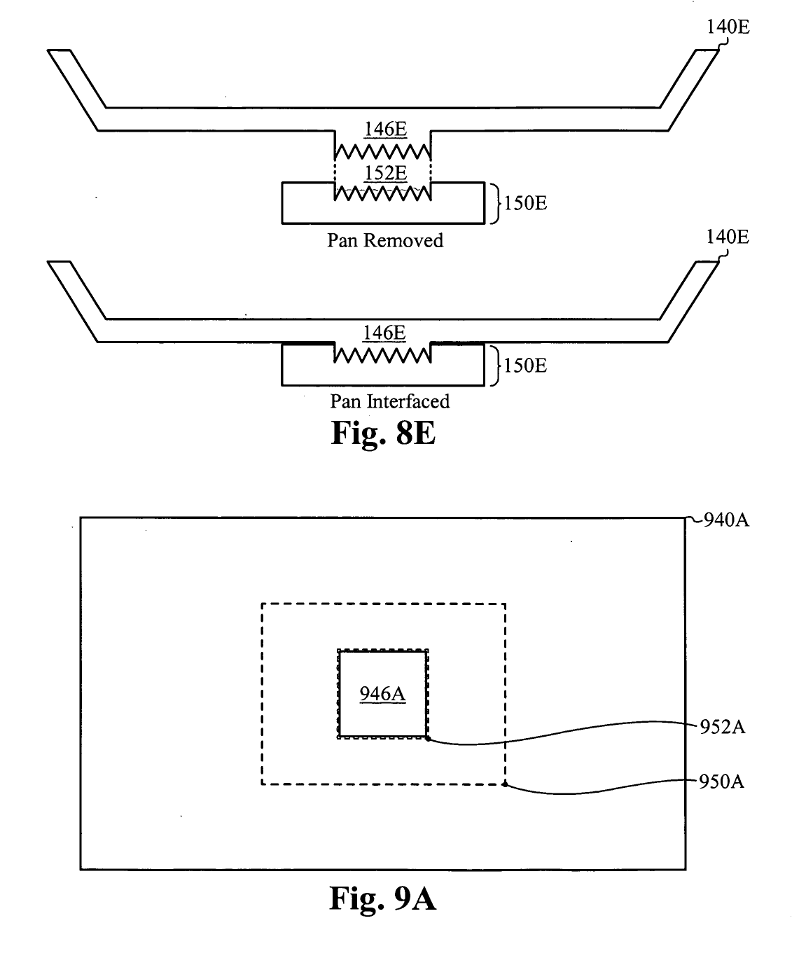

FIG. 8 illustrates an embodiment where the recessed portion 852 is located on a bottom surface of the pan 840, and the protrusion 846 is located on a top surface of the transfer plate 850. Advantageously, the recessed portion 852 does not affect the form factor of the pan 840. Hence, the pan 840 of these embodiments lies flat when placed on a flat surface, such as on a counter top, in a refrigerator, or in an oven for example. Also, the protrusion 846 of these embodiments is disposed within the base 860, and is thus protected from damage and/or undesirable contact with other surfaces.

FIG. 8 also includes a close up view of the particular mating features of some embodiments. For instance some embodiments include a locking feature that provides additional securing force and/or contact strength for improved thermal interfacing and/or transfer. The locking feature includes a variety of forms in different embodiments. Particularly, some embodiments include a screw type interlocking feature. These embodiments preferably include a circular shaped pan thereby permitting rotation of the pan. Such a circular shaped pan in accordance with some embodiments is illustrated in FIG. 7B.

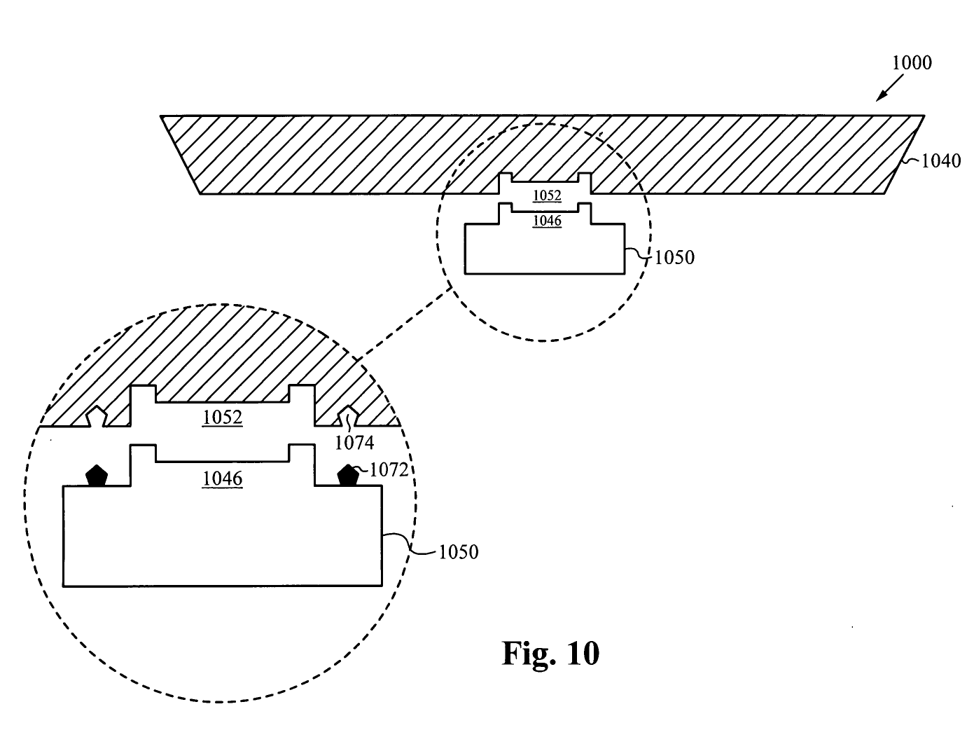

Alternatively, as illustrated in the close up, some embodiments employ a nub 872 and lip 874 locking arrangement. These embodiments typically require additional force and/or a particular motion to disengage the pan 840 from the transfer plate 850. FIG. 10 illustrates that the interlocking features of various embodiments are implemented differently. For instance, in additional embodiments, the interlocking features 1072 and 1074 are separate from the protrusion 1046 and the recessed portion 1052. Moreover, as further illustrated in FIG. 8, some embodiments include a means for a fluid or other material to be inserted between the pan 840 and the transfer plate 850.

For instance, some embodiments have a thermal transfer fluid disposed between the pan 140 and the transfer plate 150. The fluid further enhances the heat transfer between the pan 140 and the transfer plate 150. It will be understood that a non-toxic thermal transfer fluid is used. Preferably, the heat transfer fluid is water. The transfer plate 150 of some of these embodiments further has a feature to retain the fluid such as a well 154 which retains the fluid within a perimeter of the transfer plate 150. The well 154 of some embodiments is separate from the recessed portion 150, while the well 154 of other embodiments is integrated with the recessed portion 152. For instance, the well 154 can include a recessed groove that extends fully around the perimeter of the transfer plate 150, while alternatively, the well 154 is formed by virtue that the protrusion 146 is slightly smaller than recessed portion 150, thereby leaving a perimeter space (for the fluid) between the protrusion 146 and the recessed portion 150, when their surfaces are mated. The well 154 can provide an indicator or an icon for a preferred fluid level.

As suggested above, good thermal contact between the pan 140 and the transfer plate 150 improves the efficiency of the server 100. Separately, or in conjunction with, the protrusion 146 and recessed portion 152 described above, the bottom surfaces of the pan 140 and/or upper surfaces of the transfer plate 152 can be treated or engineered such that these surfaces are substantially smooth such that substantial intimate contact is made therebetween. Advantageously, these embodiments minimize the air space between the abutting surfaces of the pan 140 and the transfer plate 152. Since air typically acts as a thermal insulator, any air space between the pan 140 and the transfer plate 152 undesirably serves as an insulator, and diminishes thermal conduction.

Alternatively, or in conjunction with the thermal transfer fluid, some embodiments include an additional material disposed between the pan 140 and the transfer plate 150. For instance, some embodiments further include a structure composed of a wire mesh material, such as a copper or aluminum material. The material of these embodiments is configured to further enhance thermal transfer. Moreover, in further alternative embodiments, the thermal interface includes a roughened surface. In these embodiments, an increased amount of the thermal transfer fluid is held in place by the roughened surface, which improves the thermal transfer between the pan 140 and the transfer plate 152.

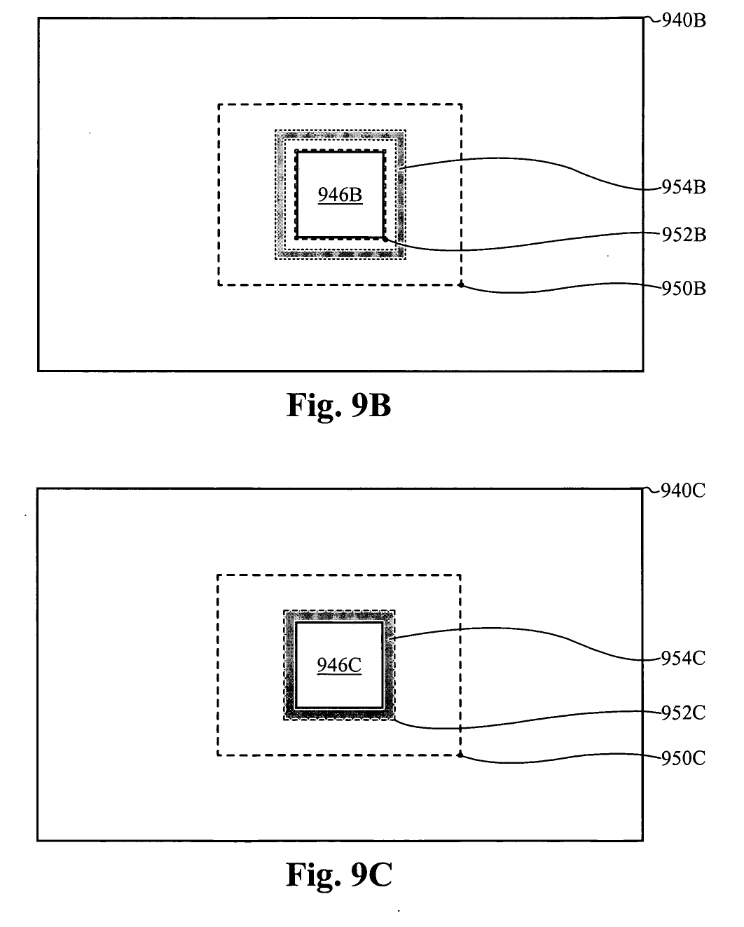

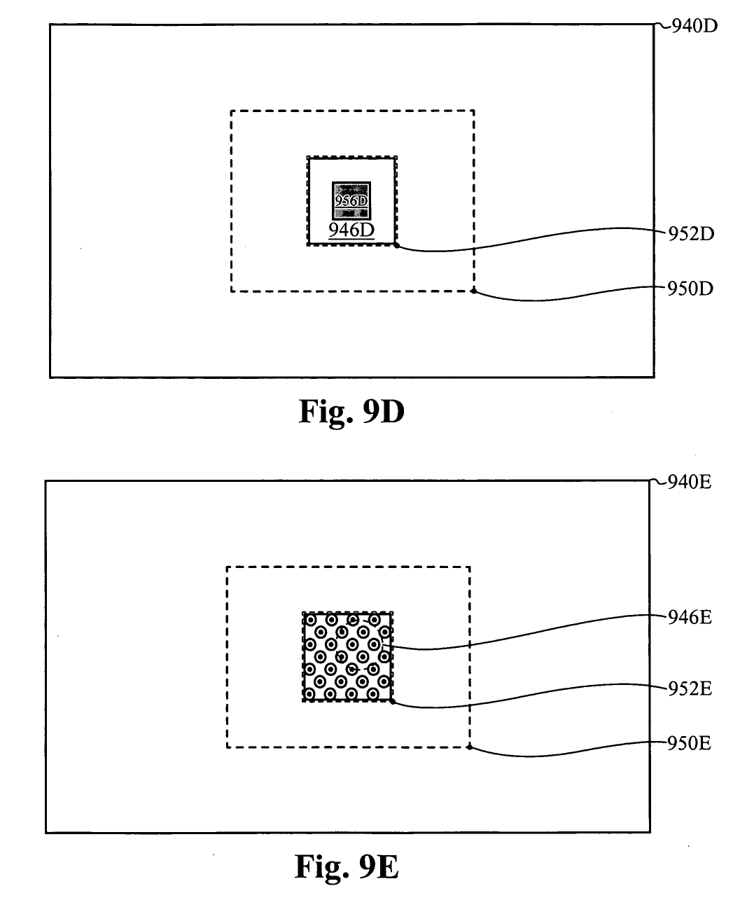

FIGS. 8A-8E and 9A-9E illustrate various examples of some of the embodiments described above. For instance, FIG. 8A illustrates a side view of a pan 140A interfacing with a transfer plate 150A according to some embodiments. In FIG. 8A, the protrusion 146A and the recessed portion 152A fit closely together.

FIG. 8B illustrates a side view of a protrusion 146B interfacing with a transfer plate 150B that has a recessed portion 152B and an additional peripheral groove 154B in accordance with some embodiments.

FIG. 8C illustrates a side view of a protrusion 146C interfacing with a transfer plate 150C that has a recessed portion 152C that is slightly larger than the protrusion 146C such that the peripheral groove 154C is integrated with the recessed portion 152C.

FIG. 8D illustrates an additional well 156D within the recessed portion 152D.

FIG. 8E illustrates a roughened surface for the protrusion 146E and/or the recessed portion 152E.

FIG. 9A illustrates a plan view of a protrusion 146A on the bottom of the pan 140A of FIG. 8A interfacing with a closely fitting recessed portion 152A of a transfer plate 150A according to some embodiments.

FIG. 9B illustrates a plan view of the protrusion 146B of FIG. 8B interfacing with a transfer plate 150B that has a recessed portion 152B and an additional peripheral groove 154B in accordance with some embodiments.

FIG. 9C illustrates a plan view of the protrusion 146C of FIG. 8C interfacing with a transfer plate 150C that has a recessed portion 152C that is slightly larger than the protrusion 146C such that the peripheral groove 154C is integrated within the recessed portion 152C.

FIG. 9D illustrates an additional well 156D within the recessed portion 152D of FIG. 8D.

FIG. 9E illustrates a roughened surface for the protrusion 146E and/or the recessed portion 152E of FIG. 8E.

Moreover, the pan 140 of some embodiments abuts only the transfer plate 150 such that the surface of the pan 140 that is not in contact with the transfer plate 150, is surrounded by a fluid. Alternatively, the base 160 of some embodiments includes one or more small pads at an edge of the pan 140 to stabilize the pan 140 while the pan 140 is inserted into the base 160. However, even in these embodiments, the contact between the pan 140 and any surface other than the transfer plate 150, is minimized. In some embodiments, the fluid surrounding the pan 140 comprises air, which provides a thermal buffer between the base 160 of the server 100 and the pan 140. Further, in some embodiments, the region of the base 160 surrounding the transfer plate 152 and away from the pan. 140 includes a thermal insulation layer 158. Preferably, this thermal insulation layer 158 has a foam component, and provides further thermal insulation of the pan 140 and/or the transfer plate 152, from the server 100, particularly the base 160 and its other components. In some embodiments, a hermetic seal is formed between the insulation layer 158 and the thermoelectric device 163. A cross section of such an exemplary embodiment is illustrated in FIG. 5.

While the invention has been described with reference to numerous specific details, one of ordinary skill in the art will recognize that the invention can be embodied in other specific forms without departing from the spirit of the invention. Thus, one of ordinary skill in the art will understand that the invention is not to be limited by the foregoing illustrative details, but rather is to be defined by the appended claims.

What is claimed is:

1. A buffet server comprising:
a thermoelectric device for providing a temperature that varies from an ambient temperature;
a base for housing the thermoelectric device;
a pan for receiving the temperature;
a transfer plate interposed between the pan and the thermoelectric device, the transfer plate for providing a thermal transfer interface,
wherein the pan, when empty, abuts only the transfer plate such that the surface of the pan that is not in contact with the transfer plate is surrounded by a fluid.

2. The buffet server of claim 1, wherein the fluid surrounding the pan comprises air, wherein the air provides a thermal buffer.

3. The buffet server of claim 1, wherein the transfer plate is coupled to the thermoelectric device by a thermally conductive material.

4. The buffet server of claim 1, wherein the pan comprises a protrusion, wherein the transfer plate comprises a recessed portion that mates with the protrusion.

5. The buffet server of claim 1, wherein the transfer plate comprises a well for retaining a fluid within a perimeter of the transfer plate.

6. The buffet server of claim 5, wherein the well provides an indicator for a preferred fluid level.

7. The buffet server of claim 5, wherein the well comprises a recessed groove that extends fully around the perimeter of the transfer plate.

8. The buffet server of claim 1 further comprising an insulation layer deposed between the pan and the base, the insulation layer comprising a foam core.

9. The buffet server of claim 8 further comprising a hermetic seal between the insulation layer and the thermoelectric device.

10. The buffet server of claim 1, wherein the pan has the dimensions of a standard consumer size serving tray.

11. The buffet server of claim 1, wherein the pan has the dimensions of a standard commercial size serving tray.

12. The buffet server of claim 1 further comprising a pan cover for enclosing the contents of the pan.

13. The buffet server of claim 12, wherein the pan cover comprises a polypropylene type material.

14. The buffet server of claim 12, wherein the pan cover comprises a polyethylene type material.

15. The buffet server of claim 12, wherein trepan cover is configured to mate with the bottom of the pan such that the pan and the pan cover are stackable.

16. The buffet server of claim 1, further comprising a server cover for enclosing the buffet server.

17. The buffet server of claim 16, wherein the server cover comprises a poly carbonate type material.

18. The buffet server of claim 1 further comprising:
a first fan configured to provide vertical air flow; and
a second fan configured to provide horizontal air flow.

19. The buffet server of claim 1, wherein the base provides a clearance for air passage.

20. The buffet server of claim 1 further comprising a vent on a side of the base.

21. The buffet server of claim 1, wherein the thermoelectric device further comprises a Peltier type device.

22. The buffet server of claim 1 further comprising a control module for adjusting the temperature.

23. The buffet server of claim 22, wherein the control module is configured to receive a desired temperature setting.

24. The buffet server of claim 1 further comprising a display for indicating a temperature setting.

25. The buffet server of claim 24, wherein the display presents the temperature in degrees Farenheit and Celsius.

26. A buffet server comprising:
a thermoelectric device for providing a temperature that varies from an ambient temperature;
a base for housing the thermoelectric device;
a pan for receiving the temperature;
a transfer plate interposed between the pan and the thermoelectric device, the transfer plate for providing a thermal transfer interface,
wherein the thermal transfer interface comprises a protrusion and a recessed portion,
wherein the recessed portion is configured to mate with the protrusion.

27. The buffet server of claim 26, wherein the recessed portion is configured for mating with the protrusion such that the pan and the transfer plate align in a predetermined configuration.

28. The buffet server of claim 26, wherein the mating configuration of the recessed portion and the protrusion are such that thermal transfer is enhanced.

29. The buffet server of claim 26, further comprising a thermal transfer fluid deposed between the pan and the transfer plate.

30. The buffet server of claim 26, further comprising an interlocking feature for securing the pan to the transfer plate.

31. The buffet server of claim 26, wherein the pan comprises a circular shape.

32. A buffet server comprising:
a thermoelectric device for providing a temperature that varies from an ambient temperature;
a base for housing the thermoelectric device;
a pan for receiving the temperature;
a transfer plate interposed between the pan and the thermoelectric device, the transfer plate for providing a thermal transfer interface,
wherein the pan comprises a standard size.

33. The buffet server of claim 32, wherein the transfer plate comprises a well for retaining a fluid within a perimeter of the transfer plate.

34. The buffet server of claim 32, wherein the pan comprises a standard consumer size serving tray.

35. The buffet server of claim 32, wherein the pan comprises a standard consumer size of 9 inches by 13 inches.

36. The buffet server of claim 32, wherein the pan comprises a standard commercial size serving tray.

37. The buffet server of claim 32, wherein the pan comprises a common fraction of a commercial size serving tray.

38. The buffet server of claim 32, wherein the pan comprises one half the size of a standard commercial size serving tray.

39. The buffet server of claim 32, wherein the pan comprises a circular shape.
